(19) United States
(12) Patent Application Publication
(10) Pub. No.: US 2002/0107701 A1
(43) Pub. Date: Aug. 8, 2002

(54) Systems and methods for metering content on the internet

(76) Inventors: Robert L. Batty, Walnut Creek, CA (US); Robert H. Halstead JR., Belmont, MA (US); James C. Mathiesen, Arlington, MA (US); Murray S. Mazer, Arlington, MA (US); Spiro Michaylov, Arlington, MA (US)

Correspondence Address: FISH & NEAVE, 1251 AVENUE OF THE AMERICAS, 50TH FLOOR, NEW YORK, NY, 10020-1105, US

(21) Appl. No.: 09/877,636

(22) Filed: Jun. 8, 2001

Related U.S. Application Data
(60) Provisional application No. 60/265,929, filed on Feb. 2, 2001.

(51) Int. Cl. G06F 17/60

(52) U.S. Cl. 705/1; 705/59

(57) ABSTRACT

Systems and methods for metering Internet content deployed by content providers based on a technology platform licensed from content technology providers are provided. The systems and methods of the present invention consists of a metering infrastructure that enables content providers to meter the usage of content deployed with their technologies. The technologies are licensed to content providers, and the licensing fees are based on the content usage by content users. Content providers are charged a licensing fee for the usage of commercial content. In a preferred embodiment, non-commercial content may be deployed based on the licensed technologies and may be distributed free of charge.

### REFERENCE TO RELATED APPLICATION

The present application claims the benefit of U.S. provisional patent application Serial No. 60/265,929, filed Feb. 2, 2001.

### FIELD OF THE INVENTION

The present invention relates generally to monitoring the distribution and execution of content on the Internet. More specifically, the present invention provides systems and methods for metering content distributed on the Internet and deployed by content providers with licensed technologies.

### BACKGROUND OF THE INVENTION

The Internet and the World Wide Web (hereinafter “the web”) have revolutionized the ways in which digital content is disseminated and shared. At any given time, the web enables millions of users worldwide to simultaneously access a wide variety of content and engage in activities as diverse as shopping, recreation, financial trading, among others. Web content may include text, audio, graphics, imagery, and video, and nearly any other type of content that may be experienced through the use of a computer or other Internet appliances, such as personal digital assistants and electronic organizers.

To create and distribute rich and interactive content on the web requires the use of content development software and/or technology platforms that are developed by content technology providers. Content development software uses a set of conventions, standards, tools, formats, or languages to represent content as strings of bits or characters when stored as files or communicated over the Internet. Technology platforms consist of a set of integrated technologies that enable content providers to develop and deploy more sophisticated web-based applications. The technology platforms may be used with existing content development software or in place of it.

Examples of languages and standards to represent content include the HyperText Markup Language (HTML) for formatted text, the JPEG standard for images, the MPEG standard for video, and the Java™ language for programs (Java™ is a trademark of Sun Microsystems, of Palo Alto, Calif.). Popular content development software includes FrontPage, from Microsoft Corporation, of Redmond, Wash., and Flash™ from Macromedia, Inc., of San Francisco, Calif. Currently available technology platforms include the digital rights management solutions offered by InterTrust Technologies Corporation, of Santa Clara, Calif., and the CURL™ technology, from CURL Corporation, of Cambridge, Mass. The CURL™ technology offers a content language (Curl: A Gentle Slope Language for the Web, M. Hostetter, D. Kranz, C. Seed, C. Terman, S. Ward, MIT Laboratory for Computer Science World Wide Web Journal, Volume II, Issue 2, Spring 1997), a development environment for creating web-based applications with the content language, and a execution engine for executing and displaying CURL content. The CURL language, described in commonly owned, copending, U.S. patent application Ser. No. 09/677,482, has been designed to represent many types of content in a single high-performance language that dramatically reduces the cost, time, and effort required to distribute rich and interactive content on the Internet.

The content development software and technology platforms are used by content providers to deliver content and information to users. Such content providers include news agencies and organizations such as the Associated Press, of New York, N.Y., and the Cable News Network (CNN), of Atlanta, Ga., that serve as a source of news, photos, graphics, audio, and video for millions of people a day, business organizations such as Microsoft Corporation, of Redmond, Wash., and Amazon.com, Inc., of Seattle, Wash., that provide company and product information on the Internet, as well as any other individual, community, or organization that delivers digital content to Internet users.

The digital content is displayed to users on a multimedia composition called a “web page.” The web page is displayed on a “web browser window” by “web browser software”, such as Internet Explorer, available from Microsoft Corporation, installed on the user's computer. Under the control of the user, the web browser software establishes a connection over the Internet between the user's computer (“the client”), and a “web server.” The web server is maintained by the content provider and consists of one or more machines running special purpose web server software. The Internet connection established between the client and the web server is used to download data representing a web page from the web server to the client.

The web page is usually interactive, and may contain user selectable links that cause other web pages to be displayed, forms that may be used to send information from the user to the web server, interactive executable code, or other elements through which the user may interact with web pages. A group of one or more interconnected and closely related web pages, such as all the pages containing information about a single business organization, located on one or more web servers, is referred to as “web site.” A web site is typically created by a content provider using one or more technologies. Alternatively, the content provider may choose to contract an independent software developer, consultant, or an Application Service Provider (ASP) to generate its web site.

The web browser software is also responsible for processing the content before it is presented to the user on the web browser window. Such processing involves fetching the content from either a local storage medium (i.e., CD-ROM or hard disk) in the client or a web server, and executing and interpreting the fetched content appropriately. The web browser software is capable of processing content represented with several common languages and standards, including HTML, JPEG, and Java™, among others. These browsers also accommodate content created with more sophisticated content development software and technology platforms, such as Flash™ and CURL, through loadable software modules commonly referred to as “plug-ins.”

Traditionally, content technology providers maintain a relationship or partnership with content providers, who, in turn, maintain a similar, albeit unrelated, relationship with users. These relationships establish the business and legal conditions under which content development software, technology platforms, and content are used and distributed on the Internet.

The first relationship, between content technology providers and content providers, may specify that (1) content technology providers deliver their technologies to content providers free of charge, that (2) content technology providers sell their technologies to content providers, or that (3) content technology providers deliver their technologies to content providers according to a licensing agreement that establishes a licensing fee for using their technologies. In general, the first option is chosen by content technology providers when their technologies are distributed for educational and non-profit purposes, or in an open source environment, when the technology is intended to be freely shared, improved, and redistributed by content providers. The second and third options are typically selected by content technology providers as viable revenue sources.

While many technologies are available free of charge, such as HTML, PERL, JPEG, and MPEG, content providers quite often are required to purchase or license more sophisticated technologies that are capable of creating the fast, dynamic, and visually engaging web sites that users demand. An example of a content development software product that can be purchased by content providers to create web sites includes FrontPage by Microsoft Corporation. Examples of content technology providers that license their technologies to content providers include InterTrust Technologies Corporation, of Santa Clara, Calif., and CURL Corporation, of Cambridge, Mass.

Similarly, while free service is the most prevalent form of content distribution by content providers to users of the Internet, an increasing number of content providers have preferred to (1) sell their content to users or to (2) enter into licensing agreements with them. In the first case, users are charged a onetime fixed fee upon access or retrieval of content from the content providers' web site, for example, when archived magazine articles are retrieved from a magazine publisher's web site. In the second case, the licensing agreement may vary according to time, such as online subscriptions offered by the Wall Street Journal, of New York, N.Y., usage, such as the number of page hits it takes a user to access the content in the content providers' web site, as in the lexis.com website, maintained by Lexis-Nexis, of Dayton, Ohio, or other conditions agreed upon between the content provider and the users.

In contrast, the licensing agreements between content technology providers and content providers are mainly based on the demands and specifications of the content providers as agreed upon by the content technology providers. The licensing agreements of a given set of technologies only depend on the usage of the technologies by the content provider. Even though the licensed technologies directly affect the end user experience, the licensing agreements do not depend on the eventual content usage by users on the Internet. This is because there are currently no provisions in place for the content technology provider to meter the content that is deployed with its technologies. The content usage is typically measured by the content providers themselves, who more than often will not disclose that data, or estimated by third party companies, such as Juniper Media Metrix, Inc., of New York City, N.Y., and NetRatings, Inc., of Milpitas, Calif. This estimation is only available after the content has been deployed in the Internet for some time.

Furthermore, the content technology providers cannot achieve live access control of the content on the Internet that has been created by a content provider. As a result, the content technology providers are not capable of marketing their technologies to content providers based on the usage of the content deployed with the technologies. When content technology providers develop technologies that provide faster downloads, quicker response times, and enable content providers to create web-based applications with richer content, an eventual increase in the usage of the web-based applications may be attributed to the technologies. Higher usage may result in higher revenues for the content provider, including ad-based revenues that are typically calculated according to content usage.

In view of the foregoing, it would be desirable to provide systems and methods for metering the content and applications distributed on the Internet and deployed by content providers with licensed technologies.

It further would be desirable to provide systems and methods for content technology providers to price the license of their technologies according to how the content and applications deployed with their technologies are used on the Internet.

It still further would be desirable to provide systems and methods for content technology providers to have live access control of the content on the Internet deployed by a content provider using the technology licensed by the content technology provider.

It also would be desirable to provide systems and methods for content technology providers to meter content distributed on the Internet and deployed with their technologies for better marketing and maintenance of their technologies.

### SUMMARY OF THE INVENTION

In view of the foregoing, it is an object of the present invention to provide systems and methods for metering the content and applications distributed on the Internet and deployed by content providers with licensed technologies.

It is a further object of the present invention to provide systems and methods for content technology providers to price the license of their technologies according to how the content and applications deployed with their technologies are used on the Internet.

It is a still further object of the present invention to provide systems and methods for content technology providers to have live access control of the content on the Internet deployed by a content provider using the technology licensed by the content technology provider.

It is also an object of the present invention to provide systems and methods for content technology providers to meter content distributed on the Internet and deployed with their technologies for better marketing and maintenance of their technologies.

These and other objects of the present invention are accomplished by providing systems and methods for metering a content item distributed on the Internet and deployed by content providers with technologies licensed by content technology providers. A content technology provider offers content development software or technology platforms that enable the development and deployment of web-based applications by content providers to deliver rich and interactive content to users. The content item may be a document, image, data, digital media, applet, application, or any other type of deployable content on the Internet. All these types of content items are referred to hereinafter as “applets.” It should be noted that an applet according to the definition herein is not necessarily executable since it may comprise content such as documents, images, data, and further non-executable media. Each such applet may import one or more other applets (which may be referred to as “packages”). Since some applets may not be executable, executing an applet as used herein includes processing the applet and its contents. For example, processing an applet consisting of an image may involve rendering the image into a displayable form, and processing an applet consisting of a spreadsheet may involve displaying or performing calculations on the spreadsheet. For purposes of this application, deploying an applet may include creating, displaying, executing, or otherwise, processing the applet.

The systems and methods of the present invention consist of a metering infrastructure that enables content technology providers to meter the usage of applets deployed with their technologies. The technologies are licensed to content providers, and the price of the license is based on the usage of the metered applets. In a preferred embodiment, content providers are charged only for usage of the metered applets that are labeled as containing commercial content. Non-commercial applets may be deployed and distributed free of charge.

In a preferred embodiment, the systems and methods of the present invention involve six main components: (1) a metering module to meter the applet which is based on the licensed technologies; (2) a metering server associated with the content technology provider to process the information collected by the metering module; (3) a metering database associated with the metering server to store the information processed by the metering server; (4) a verification server for verifying the licensing information; (5) a financial data warehouse to use the information stored in the metering database to update the licensing fees of the content provider; and (6) an account server for content providers to manage their licenses with the content technology provider.

The metering module collects information about every display and execution of applets deployed with the licensed technology. In a preferred embodiment, the metering module is part of an execution engine that may be easily integrated into web browser software on a user's computer to view and process content deployed with the licensed technology. The information collected is placed in a metering record that includes fields such as a licensing ID identifying the content provider that generated the applet, a timestamp for the display and execution of the applet, the size of the applet being displayed or executed, the type of applet being displayed or executed, among others. The metering record is generated without requiring any special software to be installed on the content providers' web servers. In addition, the metering record preferably does not include any information that may interfere with the privacy of content users.

Metering records may be created at the moment the loading of an applet into memory on the user's computer has completed. Alternatively, the metering record may be created earlier, such as while the applet is loading, or later, such as when the user accesses the applet or the applet execution is terminated. When the applet has finished loading, the metering module may determine whether the applet imports any other package generated with the licensed technology, so that a metering record would be generated for each imported package. In this case, preferably only one metering record would be generated for a package that is imported more than once. For example, the user may execute an applet created by a content provider that imports the same package more than once. A metering record would be created to meter the usage of the applet, and just one more metering record would be created to meter the usage of the package even though the package is imported more than once.

The metering records generated by a given metering module may be transmitted to a metering server associated with the content technology provider. Alternatively, the metering records may be saved in a metering file if the metering server cannot be reached, if the user is off-line, or in order to achieve greater efficiency by transmitting multiple metering records in one transaction. The metering file may be periodically transmitted to the metering server, depending on the size of the file, on whether the metering module is running when the file is transmitted, and on whether the user will incur any delays in accessing the applet due to the transmission of the metering file.

The metering server processes the metering records in the metering file and stores the metering records in the metering database. The metering records in the metering database may be periodically transmitted to a verification server that checks the validity of the content providers' licenses. In case the verification server determines that an applet being executed by a user was generated by a content provider with an invalid license, the verification server may notify the user and, eventually, terminate the execution of the applet.

The metering server also periodically transmits the metering records in the metering database to a financial data warehouse that handles the proper billing and payment of the licensing fees charged by the content technology provider to the content provider. The billing is determined based on the metering records. In addition, the financial data warehouse interacts with an account server associated with content providers, so that content providers can better manage licenses with the content technology provider. The account server enables the content provider to keep track of the licenses and licensing fees it maintains with the content technology provider.

Advantageously, the present invention enables a content technology provider to have live access control of the applets on the Internet that have been deployed by a content provider using licensed technologies. The present invention also enables a content technology provider to license its technologies to content providers according to how the applets deployed with the technologies are distributed and executed on the Internet.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is an illustrative view of the parties and relationships involved in the creation, distribution, and execution of content in accordance with the principles of the present invention;

FIG. 2 is a schematic diagram illustrating the distribution of content between content providers and content users in accordance with the principles of the present invention;

FIG. 3 is a schematic view of the license categories used in a preferred embodiment between content technology providers and content providers;

FIG. 4 is a schematic view of the licensing tag embedded into content deployed based on the licenced technologies;

FIG. 5 is a schematic view of the components used in a preferred embodiment of the present invention;

FIG. 6 is an illustrative view of the system and the network environment in which the present invention operates;

FIG. 7 is a flowchart for using the execution engine to execute and meter content deployed with the licensed technology;

FIG. 8 is an illustrative view of a metering record generated in accordance with the principles of the present invention; and

FIG. 9 is a flowchart for transmitting a metering file to the metering server.

### DETAILED DESCRIPTION OF THE INVENTION

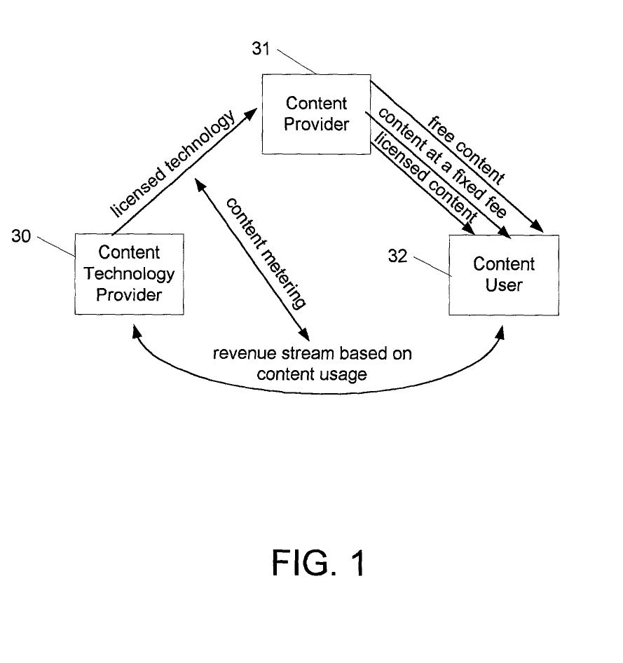

Referring to FIG. 1, an illustrative view of the parties and relationships involved in the creation, distribution, and execution of content in accordance with the principles of the present invention is described. Content technology provider 30 is a designer and developer of content development software and technology platforms that are used to build and deploy content, such as web-based applications or applets which may be displayed and executed through a web browser. Alternatively, other software packages could be used to display and/or execute content. The applets may be embedded into a web page to display rich and interactive content such as animations, forms, pop-up dialog boxes, financial applications, and tutorials, among others. Each applet may be developed using one or more content development software and technology platforms.

Content development software uses a set of conventions, standards, tools, formats, or languages to represent content as strings of bits or characters when stored as files or communicated over the Internet. Examples of languages and standards used to represent content include HTML, PERL, JPEG, MPEG, Java™, and the CURL language, described in commonly owned, copending, U.S. patent application Ser. No. 09/677,482.

Technology platforms are a set of integrated technologies, languages, and/or standards used to deploy more sophisticated content and a better user experience than that provided by existing content development software. An example of such a technology platform is the CURL technology, from CURL Corporation, of Cambridge, Mass. The CURL technology consists of the CURL language, a development environment for creating applets written in the CURL language, and an execution engine for executing and displaying CURL applets. The execution engine is used, for example, in a web browser plug-in that enables CURL applets to be executed in a web browser. CURL applets are compiled and executed by the execution engine at the user's computer, thus significantly reducing the time required for executing and downloading a web page from a web server. In particular, the CURL technology offers considerable performance gains in highly-interactive applications that require extensive communication between the user's computer and the web server, such as financial, entertainment, and travel applications on the web.

Content provider 31 uses the technologies developed by content technology provider 30 to create and deliver applets to content user 32 by means of a web site. Content provider 31 may be a commercial or non-commercial content provider. Commercial content providers are content providers that generate revenues from their Internet content, while non-commercial content providers distribute content for non-profit purposes. Examples of content provider 31 include news agencies and organizations such as the Associated Press, of New York, N.Y., and the Cable News Network (CNN), of Atlanta, Ga., business organizations such as CURL Corporation, of Cambridge, Mass., and Amazon.com, Inc., of Seattle, Wash., as well as any other individual, community, or organization that delivers digital content to content user 32.

In delivering content to content user 32, content provider 31 may choose one of three options: (1) deliver the applets for free; (2) charge a fee for the applets; or (3) license the applets. The first option is currently the most common, with millions of web pages freely available to content users around the world. Typically, this option is chosen by non-commercial content providers for educational, governmental, and non-profit purposes in general, such as individual content providers creating web pages for their families, universities, city governments, among others. Commercial content providers such as news and business organizations choose this option to increase the users' awareness of their business operations, to advertise their products, or to provide electronic marketplaces, among others. The revenues generated by commercial content providers in this case may be sales-based revenues, as a result of web site sales to content users, or ad-based revenues, as a result of web site sales of advertisement space.

The latter two options are chosen by content provider 31 when there is a need to generate additional revenue from the content itself. With the second option, content provider 31 charges content user 32 a one-time fixed fee upon access or retrieval of content from the web site maintained by content provider 31, for example, when archived magazine articles are retrieved from a magazine publisher's web site. With the third option, content provider 31 has a licensing agreement with content user 32 that may vary according to time, such as online subscriptions offered by the Wall Street Journal, of New York, N.Y., usage, such as the number of page hits it takes a user to access content in the content providers' web site, as in the lexis.com website, maintained by Lexis-Nexis, of Dayton, Ohio, or other conditions agreed upon between the content provider and the users. It should be understood by one skilled in the art that the license established between content provider 31 and content user 32 is not necessarily subject to a licensing fee. A non-commercial provider may also choose to license content to content users under certain conditions without imposing a licensing fee.

Similarly, content technology provider 30 has a licensing agreement with content provider 31. The licensing agreement establishes that content provider 31 may use the technologies developed by content technology provider 30 to deploy content for use by content user 32. In a preferred embodiment, the technologies are licensed subject to a licensing fee depending on the status of content provider 31. If content provider 31 is deploying non-commercial content based on the licensed technologies developed by content technology provider 30 solely for educational and non-profit purposes, then content provider 31 may use the technologies free of charge, that is, no licensing fee is imposed.

Otherwise, if content provider 31 is deploying commercial content to content user 32 based on technologies licensed by content technology provider 30 for the purpose of attracting or transacting commerce, then a licensing fee is imposed. The licensing fee is calculated based on the usage of the applets deployed by content provider 31 based on the technologies licensed by content technology provider 30. The usage of the applets is metered by content technology provider 30 as described hereinbelow.

A licensing fee is imposed on commercial content providers since the technologies licensed by content technology provider 30 directly affect the web experience of content user 32 and contribute to the revenue sources of commercial content providers. In offering technologies that provide faster downloads, quicker response times, and the ability to create applets with richer content, content technology provider 30 is partially responsible for increasing the usage of the web site maintained by content provider 31. Higher usage may result in higher revenues for a commercial content provider, including ad-based revenues that are typically calculated according to content usage. By metering content usage as described hereinbelow, content technology provider 30 gains a share of the revenues generated when richer content is executed by content user 32.

It should be understood by one skilled in the art that any one of content technology provider 30, content provider 31, and content user 32 may at any time perform the roles of each other. For example, CURL Corporation, of Cambridge, Mass., and Microsoft Corporation, of Redmond, Wash., are both content technology providers, content providers, and content users.

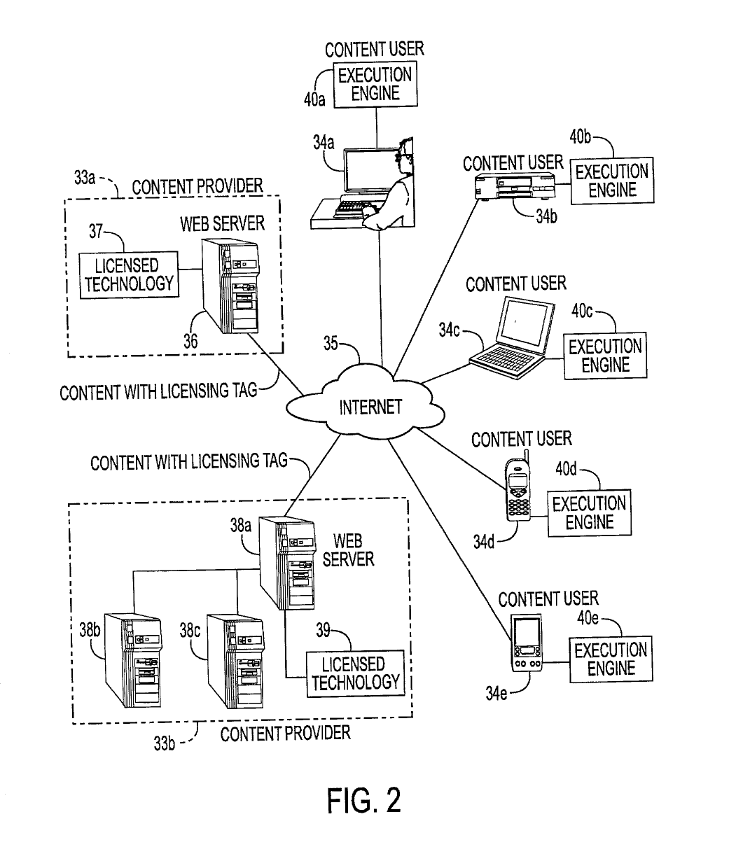

Referring now to FIG. 2, a schematic diagram illustrating the distribution of content between content providers and content users in accordance with the principles of the present invention is described. Content providers 33a-b create and deliver applets to content users 34a-e. The applets are accessed through Internet 35. Content providers 33a-b have web servers 36 and 38a-c, respectively, that execute web server software to process requests from content users 34a-e on Internet 35. Web servers 36 and 38a-c respond to these requests by sending web pages to content users 34a-e, such as web pages deployed with licensed technology 37 by content provider 33a and sent by web server 36 and web pages deployed with licensed technology 39 by content provider 33b and sent by web servers 38a-c.

Content users 34a-e may access Internet 35 by means of a variety of electronic devices, such as a personal computer (34a), a set-top box or entertainment system (34b), a notebook computer (34c), a cellular phone (34d), and a personal digital assistant (34e). Each one of the electronic devices used by content users 34a-e to access Internet 35 is equipped with web browser software to access web pages deployed by content providers 33a-b. In addition, the devices used by content users 34a-e contain execution engines 40a-e to view and execute content deployed with licensed technologies 37 and 39. Execution engines 40a-e are programs that display and execute content that is not automatically recognized by the standard web browsers, in this case, content deployed with licensed technologies 37 and 39. Execution engines 40a-e may be used, for example, in a web browser plug-in that enables content deployed with licensed technologies 37 and 39 to be executed in a web browser. Examples of popular plug-ins include the Acrobat Reader plug-in, developed by Adobe Systems, Inc., of San Jose, Calif., to view documents saved into the portable document format (PDF), the RealPlayer, developed by Real Networks, Inc., of Seattle, Wash., to display audio and video content, Shockwave, developed by Macromedia, Inc., of San Francisco, Calif., to display interactive animations, and Surge™, developed by CURL Corporation, of Cambridge, Mass., to display applets created with the CURL language.

Licensed technology 37 and licensed technology 39 are technologies developed by a content technology provider and licensed to content providers 33a-c for the purposes of creating and distributing applets to content users 34a-e. The licensing information is embedded into the applets in the form of a licensing tag created with licensed technologies 37 and 39 as described hereinbelow. Both licensed technology 37 and 39 may be subject to a licensing fee if content providers 33a-b are commercial content providers that deliver content to content users 34a-e for the purpose of generating revenues.

In a preferred embodiment, licensed technologies 37 and 39 include a content language, a development environment for creating applets with the content language, and an execution engine for executing and displaying the applets. The execution engine may be in the form of a plug-in to web browser software, fully integrated into and part of web browser software, or a standalone program associated with the web browser software. For example, execution engines 40a-e enable content users 34a-e to view and execute content deployed by content providers 33a-b with licensed technologies 37 and 39. In addition, execution engines 40a-e verify the licensing information embedded into the applets, and contain a metering module as described hereinbelow to meter the content usage by content users 34a-d.

Licensed technologies 37 and 39 may send applets to content users 34a-e as source code, intermediate code that may be partially compiled by a just-in-time (JIT) compiler incorporated into execution engines 40a-e, or as executable code. Preferably, licensed technologies 37 and 39 send applets to content users 34a-e as intermediate code. Sending the intermediate code enables content users 34a-e to have faster downloads and quicker response times since sending the intermediate code instead of the fully compiled code takes significantly less bandwidth. Conversely, the ability to compile the applets at execution engines 40a-e instead of at web servers 36 and 38a-c enables content providers 33a-b to deliver richer and more interactive content to content users 34a-e.

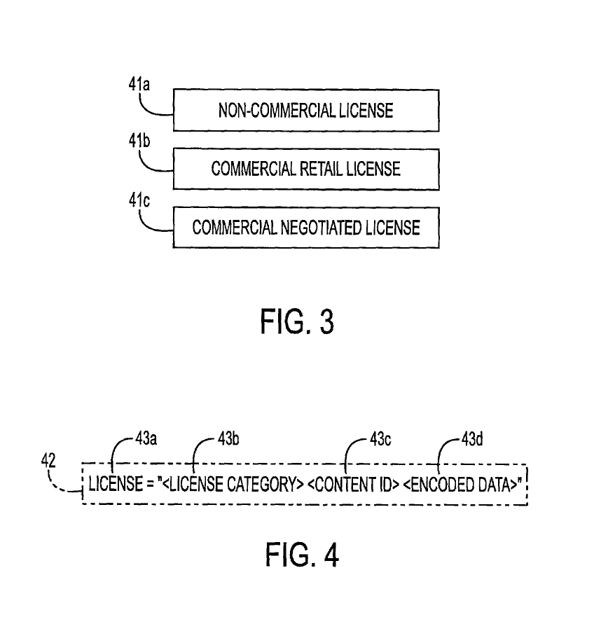

Referring now to FIG. 3, a schematic view of the license categories used in a preferred embodiment between content technology providers and content providers is described. There are three license categories that content technology provider 30 may use to license its technologies to content provider 31, depending on the status of content provider 31: (1) non-commercial license 41a; (2) commercial retail license 41b; and (3) commercial negotiated license 41c. Non-commercial license 41a is used for non-commercial content, while commercial license 41b and commercial negotiated license 41c are used for commercial content. In a preferred embodiment, there is no licensing fee associated with non-commercial license 41a.

Commercial retail license 41b incurs a licensing fee calculated in the same way for all the licensees in this license category. The licensing fee may be calculated according to the usage of the metered applet by content users 34a-e. Alternatively, the licensing fees may be calculated in many other ways, e.g., according to the size of the metered applet, the type of the metered applet, among others. All content providers having license 41b incur a licensing fee determined by a standard fee schedule based on metered applet usage. A unit of metered applet usage may be, for example, a unit of size of the applet, a unit of time of execution of the applet, or any other unit of measurement corresponding to the applet usage. In contrast, each content provider having commercial negotiated license 41c incurs a licensing fee that depends on specific licensing terms and conditions negotiated with content technology provider 30.

Referring now to FIG. 4, a schematic view of the licensing tag embedded into content deployed based on the licensed technologies is described. When an applet based on the licensed technologies is deployed by content providers, the applet is distinguished by a special licensing tag embedded into the applet file. The licensing tag is required in the present invention to verify the status of the license between the content provider and the content technology provider, to meter the applet accordingly, and to control the processing of the applet.

Licensing tag 42 is an example of a licensing tag for an applet written in the CURL language. Licensing tag 42 is identified in the applet by language construct 43a. In a preferred embodiment, licensing tag 42 is placed near the beginning of the applet file, allowing the remaining content in the file to be executed immediately after validation of licensing tag 42. The license information may be specified as a language construct or in metadata associated with the applet. The license information is validated by execution engines 40a-e downloaded by content users 34a-e to display and execute content deployed with the licensed technologies.

Licensing tag 42 contains several fields used to represent the license information. Field 43b is used to identify the license category. As shown in FIG. 3, the license category may be non-commercial license 41a, commercial retail license 41b, or commercial negotiated license 41c. Field 43c contains a content ID for identifying the content provider that deployed the applet with the licensed technology. In one embodiment, the content ID consists of a license number assigned to the content provider. In another embodiment, the content ID may be based upon the license number, the size of the applet, its content, or other properties of the applet. In this case, the license number may be extracted from the content ID. The license number is used in the present invention to send any bills associated with the usage of the applet to the appropriate content provider. The content ID may include a unique hash ID calculated according to the methods described in commonly owned, copending, U.S. patent application Ser. No. 09/676,415. Alternatively, the content ID may be a number, alphanumeric text, or any other representation specifying the ID. Similarly, the license number may be a number, alphanumeric text, or any other representation that can be used to identify the content provider.

In addition, field 43d may contain encoded data representing specific licensing provisions, such as the time period in which the license is valid, an authentication code to verify that the applet file has not been corrupted or tampered with, and the extent of the license, among others. It should be understood by one skilled in the art that there are many other ways to form licensing tag 42. For example, some of fields 43a-d may be optional, and additional fields might be provided within licensing tag 42. At a minimum, licensing tag 42 should contain a license number associated with the content provider and the license category. The contents and use of licensing tag 42 may be as described in commonly owned, copending U.S. patent application Ser. No. 09/267,269.

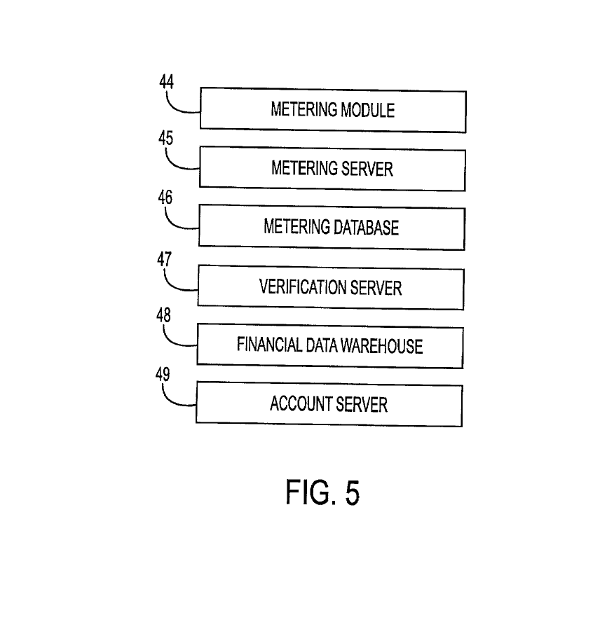

Referring now to FIG. 5, a schematic view of the components used in a preferred embodiment of the present invention is described. The components consist of: (1) metering module 44; (2) metering server 45; (3) metering database 46; (4) verification server 47; (5) financial data warehouse 48; and (6) account server 49.

Metering module 44 is a program on a content user's computer for metering content. Preferably, metering module 44 is part of an execution engine that may be easily integrated into web browser software on a user's computer to view and execute content deployed with the licensed technology, such as execution engines 40a-e used by content users 34a-e (FIG. 1). Metering module 44 collects information about every display and execution of applets based on the licensed technology. The information collected is placed in a metering record that preferably does not include any information that may interfere with the privacy of content users 34a-e.

Metering records may be created at the moment the loading of an applet into memory on the user's computer has completed. Alternatively, the metering record may be created earlier, such as while the applet is loading, or later, such as when the user accesses the applet or the applet terminates. When the applet has finished loading, metering module 44 may check whether the applet contains a valid licensing tag such as licensing tag 42 and may verify whether the applet has been modified or tampered with since its creation by the content provider. In addition, metering module 44 may maintain a “denial-of-service” file or other directory or database that indicates which license numbers are invalid. Metering module 44 may also maintain a license file to cache the license numbers whose validity has recently been ascertained. Metering module 44 also determines whether the applet imports any other applet based on the licensed technology, so that a metering record is generated for each imported applet. In this case, preferably only one metering record is generated for an applet that is imported more than once.

The metering records generated by metering module 44 may be directly transmitted to metering server 45 associated with the content technology provider. Alternatively, the metering records may be saved in a metering file if metering server 45 cannot be reached, if the user is off-line, or in order to achieve greater efficiency by transmitting multiple metering records in one transaction. The metering file may be periodically transmitted to metering server 45, depending on the size of the file, on whether metering module 44 is running, and on whether the content user will incur any delays in accessing the content due to the transmission of the metering file.

Metering server 45 processes the metering records and stores the metering records in metering database 46. Typically, metering database 46 contains a variety of tables, with each table containing one or more data categories or fields in its columns. Each row of the table contains a unique metering record for the fields defined by the columns. Alternatively, metering database 46 may be a file containing all of the metering records saved in a particular period of time.

Metering module 44 may request from verification server 47 information regarding the validity of the license associated with the applet or of an applet or package that it imports. In case verification server 47 determines that the license is invalid or has been revoked or suspended, then verification server 47 may notify the execution engine displaying and processing the applet. The execution engine may then notify the user and, eventually, terminate the execution of the applet.

Metering server 45 also periodically transmits the metering records in metering database 46 to financial data warehouse 48. Financial data warehouse 48 handles all the billing and payment of any licensing fees charged by the content technology provider to the content provider. The billing is determined based on the metering records stored in metering database 46. In addition, financial data warehouse 48 interacts with account server 49 associated with content providers who deploy applets based on the licensed technologies. Account server 49 is a web server that enables the content provider to keep track of the licenses and licensing fees it maintains with the content technology provider. Alternatively, billing and payment of licensing fees may be handled by standard invoicing.

It should be understood by one skilled in the art that the content technology provider can be an intermediary between a third party and a content provider. For example, the content technology provider may license its technologies to an original equipment manufacturer (OEM), which then provides the technologies to content providers. In this case, all the content providers may be assigned the same license number corresponding to the OEM who licensed the technologies from the content technology provider. The content technology provider may then bill the OEM for the use of any content deployed by the content providers with the technology licensed to the OEM.

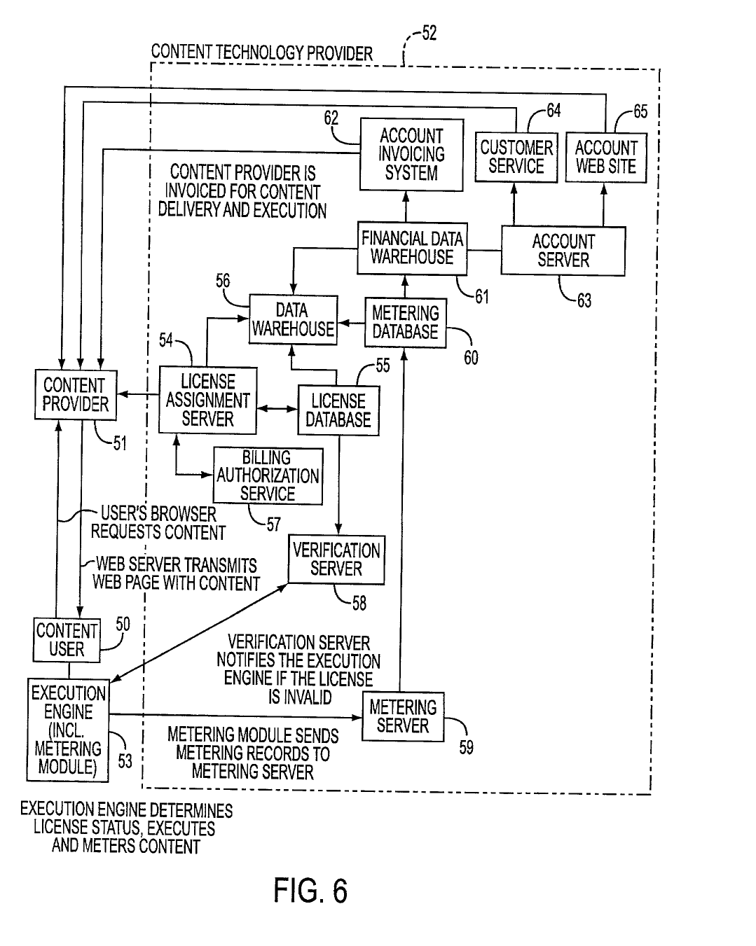

Referring now to FIG. 6, an illustrative view of the system and the network environment in which the present invention operates is described. Content user 50 uses web browser software to request content deployed by content provider 51 using technologies licensed by content technology provider 52. To display and execute content deployed with the licensed technologies, content user 50 has execution engine 53, which may be a plug-in to the web browser software in the user's computer. Execution engine 53 includes a metering module such as metering module 44 (FIG. 5) to meter the content executed by content user 50.

Prior to creating content for content user 50, content provider 51 enters into a licensing agreement with content technology provider 52 to license a technology platform from content technology provider 52. Preferably, the technology platform includes a content language or another way to represent content, an optional development environment for creating applets, and an execution engine such as execution engine 53 for displaying and processing applets. Content provider 51 downloads the technology platform from a web server maintained by content technology provider 52 or any other web server from which the technology platform may be downloaded. Alternatively, content provider 51 may obtain the content technologies via a CD-ROM, disk, tape, or any other means for distributing digital content.

The licensing agreements may be formed on the web, with on-line forms to be filled out by content provider 51. Alternatively, the licensing agreement may be formed in writing as part of a legally binding contract between content technology provider 52 and content provider 51. The on-line forms enable content provider 51 to specify the desired license category, which may be non-commercial license 41a or commercial retail license 41b (FIG. 3). In the case of commercial licenses 41b-c, content provider 51 is required to enter financial information in the on-line forms. Additionally, in an alternative embodiment, a non-commercial content provider may not need a license to use the content technologies.

The financial information is used by content technology provider 52 to charge content provider 51 for the usage of the commercial applet by content user 50 or other users. Content provider 51 may enter one or more credit card numbers in the on-line forms to be automatically used by content technology provider 52 when billing content provider 51. Alternatively, content provider 51 may make payment arrangements with content technology provider 52. The payment arrangements may include the use of on-line payment services such as the service provided by PayPal.com, of Omaha, Nebr., or the use of InternetCash™, offered as an on-line alternative to credit cards and developed by InternetCash Corporation, of New York, N.Y. Further, payment arrangements can also be made through standard invoicing. The financial information provided by content provider 51 may be stored in data warehouse 56 maintained by content technology provider 52.

Content technology provider 52 assigns one or more license numbers to each content provider, e.g., content provider 51. The license number is assigned by licensing assignment server 54 maintained by content technology provider 52. Alternatively, the license numbers may be manually assigned. Each content provider may have several license numbers, for example, for billing different types of content at different rates or for tracking purposes. Further, the license numbers assigned to different content providers may not be unique. For example, such may be the case when different content providers are using a technology licensed to an OEM. The OEM may be assigned a license number by content technology provider 52, and this license number may be distributed to all the different content providers that use the technology licensed to the OEM. Content technology provider 52 meters content deployed by all the content providers that use the technology licensed to the OEM and bills the OEM for the content usage.

Content provider 51 requests a license number from license assignment server 54, and server 54 assigns a license number to content provider 51. Any new license number that is assigned by license assignment server 54 is stored in license database 55. Conversely, any license number that is no longer in use may be removed from license database 55. The license number may be periodically refreshed by license assignment server 54 and sent to content provider 51.

Optionally, license assignment server 54 may consult billing authorization service 57 to check the validity of the financial information submitted by a commercial content provider when requesting a license number. Billing authorization service 57 is a service available through the financial relationships established between content technology provider 52 and the financial institutions responsible for any credit card numbers or accounts submitted by content provider 51. Billing authorization service 57 may be used to check the validity of the financial information entered by content provider 51 into the on-line forms corresponding to the licensing agreement with content technology provider 52.

Content provider 51 deploys applets based on the technology platform licensed from content technology provider 52. Content user 50 or other user requesting content from content provider 51 downloads, displays, and processes the applets from content provider 51. The applets may be an applet embedded into a HTML page or standalone applications deployable over an Intranet or the Internet. Each such applet deployed by content provider 51 and based on the technology platform licensed from content technology provider 52 contains a licensing tag such as licensing tag 42 (FIG. 4). In cases where an applet is found without a licensing tag, execution engine 53 may treat the applet as non-commercial, may refuse to execute the applet, or it may create a special metering record to meter applets without licensing tags.

When the device used by content user 50 executes an applet based on the licensed technology platform, execution engine 53 triggers metering module 44 to meter the usage of the applet. Execution engine 53 checks whether the applet contains a valid licensing tag and may verify whether the applet has been modified or tampered with since its creation by the content provider. In addition, execution engine 53 determines whether the applet is commercial or non-commercial by examining the licensing information in the licensing tag. If the applet is non-commercial, execution engine 53 may immediately execute the applet and metering module 44 may generate a metering record corresponding to the applet usage.

In the case of a commercial applet, execution engine 53 may determine based on a denial-of-service file or communication with verification server 58 whether the licensing tag in the applet is valid. If the licensing tag is determined to be invalid, then execution engine 53 may stop the applet execution, inform content user 50 that the applet being executed was deployed by content provider 51 using a technology with an invalid license, or may automatically execute the applet despite the invalid license.

The metering records generated by metering module 44 may be directly transmitted to metering server 59 associated with content technology provider 52. Alternatively, the metering records may be saved in a metering file if metering server 59 cannot be reached, if content user 50 is off-line, or in order to achieve greater efficiency by transmitting multiple metering records in one transaction. The metering file may be periodically transmitted to metering server 59, depending on the size of the file, on whether metering module 44 is running, and on whether the content user will incur any delays in accessing the content due to the transmission of the metering file. If metering module 44 is unable to communicate with metering server 59, the metering file is stored locally on the computer used by content user 50 until metering module 44 is able to communicate with metering server 59, or until some other condition occurs, such as the passage of a fixed period of time, or the metering file becoming too large.

Metering server 59 then processes the metering records in the metering file and stores the metering records in metering database 60. Typically, metering database 60 contains a variety of tables, with each table containing one or more data categories or fields in its columns. Each row of the table contains a unique metering record for the fields defined by the columns.

Metering server 59 also periodically transmits the metering records in metering database 60 to financial data warehouse 61. Financial data warehouse 61 handles all the billing and payment of any licensing fees charged by content technology provider 52 to content provider 51. The billing is determined based on the metering records stored in metering database 60. The billing and payment information generated by financial data warehouse 61 is sent to account invoicing system 62. Account invoicing system 62 then prepares an invoice to content provider 51, who is billed according to the financial information stored in data warehouse 56. In addition, metering server 59 may periodically store data into data warehouse 56 for use in billing, customer support, license management, management of payment terms, etc. Conversely, data from data warehouse 56 may be sent periodically to license database 55 to indicate the license numbers that are valid or invalid. Further, a manual process may be used to indicate whether the license numbers are valid or invalid. It should be understood by one skilled in the art that the functions performed by data warehouse 56 and financial data warehouse 61 may be performed by a single data warehouse.

Content provider 51 may check the status of its licenses through account server 63. Account server 63 is a web server that enables content provider 51 to keep track of its licenses and licensing fees it maintains with content technology provider 52. Content provider 51 may access this information through customer service 64 or through account web site 65. Content provider 51 is assigned a customer ID and password to enter account web site 65 to review the activity and associated billing of their content. Preferably, account web site 65 displays a billing summary and a content usage summary. The billing and content usage summaries are preferably updated every day. In addition, account web site 65 may redirect content provider 51 to license assignment server 54 whenever content provider 51 needs to activate a new license.

It should be understood by one skilled in the art that one or more of metering server 59, verification server 58, billing authorization service 57, license assignment server 54, data warehouse 56, license database 55, metering database 60, financial data warehouse 61, account invoicing system 62, customer service 64, account web site 65, and account server 63 may be maintained by a third party other than content technology provider 52.

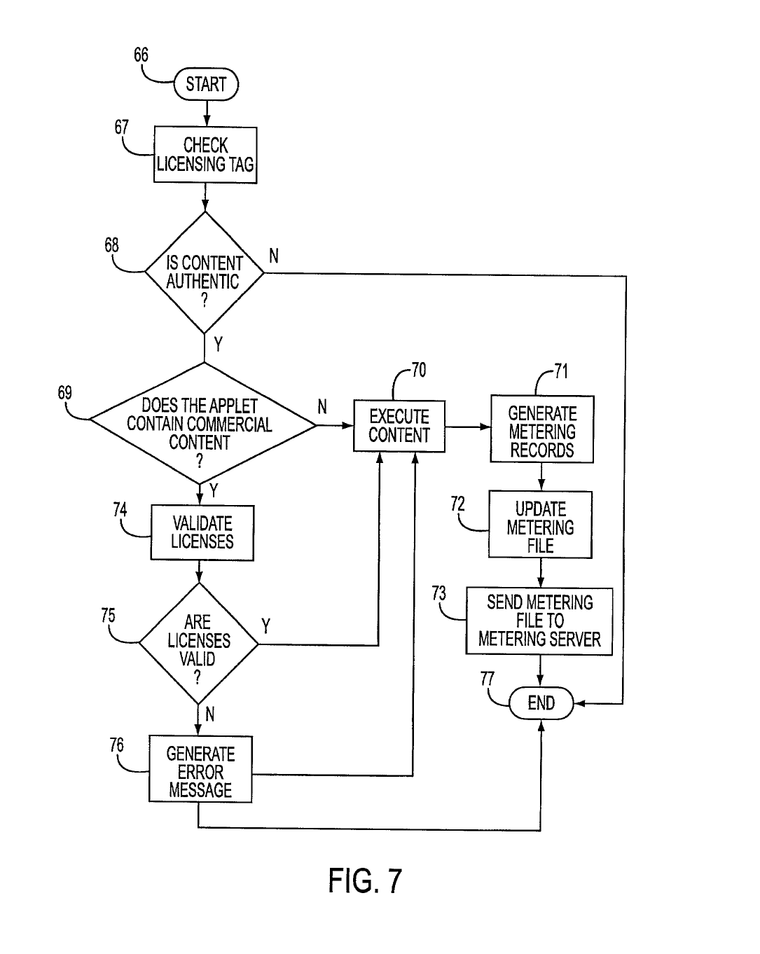

Referring now to FIG. 7, a flowchart for using the execution engine to execute and meter content deployed with the licensed technology is described. At step 67, execution engine 53 checks the applet downloaded by content user 50 for a licensing tag containing licensing information, e.g., licensing tag 42. At optional step 68, execution engine 53 may verify whether the applet file has been modified or tampered with since origination. Execution engine 53 may use the content ID stored in the licensing tag and computed as a hash of the content to determine whether the applet file is authentic. If not, its execution will be terminated.

At step 69, metering module 53 determines the license category of the applet file specified in the licensing tag. An applet file has commercial content if the licensing tag indicates the license is commercial retail license 41b or commercial negotiated license 41c. Additionally, an applet file has commercial content if the license is non-commercial license 41a but the applet imports other applets or packages that have commercial content. An applet has no commercial content if its license is non-commercial license 41a and if all its imported applets or packages also hold non-commercial licenses. In case the applet has no commercial content, execution engine 53 proceeds with the applet execution at step 70. At step 71, metering module 44 meters the applet and generates a metering record. In one embodiment, a metering record is generated for commercial and non-commercial applets. In an alternative embodiment, metering records are generated only for commercial applets. Metering module 44 also determines whether the applet imports any other package, so that a metering record is generated for each imported package. In this case, preferably only one metering record is generated for a package that is imported more than once.

The metering record may be directly transmitted to metering server 59. Alternatively, at step 72, the metering record may be saved in a metering file if the metering server cannot be reached, if the user is offline, or in order to achieve greater efficiency by transmitting multiple metering records in one transaction. At step 73, if the metering record is stored in the metering file, the metering file is transmitted to metering server 59. As described hereinabove, the metering file may be periodically transmitted to metering server 59 associated with content technology provider 52, depending on the size of the content file, on whether metering module 44 is running, and on whether content user 50 will incur any delays in accessing the content due to the transmission of the metering file.

If the applet is determined to have commercial content at step 69, execution engine 53 may request from verification server 47 information regarding the validity of the license associated with the applet or any applets that it imports. In case verification server 47 determines that the license is invalid, then verification server 47 may send a denial-of-service token to execution engine 53. If the license is determined to be valid at step 75, the applet is executed at step 70, a metering record is generated at step 71, the metering record may be stored in a metering file at step 72, and the metering file may be sent to metering server 59 at step 73. Otherwise, execution engine 53 may either ignore the invalidity of the license and continue executing the applet, or generate an error message to content user 50 and terminate the applet execution.

It should be understood by one skilled in the art that the order of the steps described hereinabove may be altered. For example, it may not be desirable to determine the authenticity of the applet or the validity of the license prior to executing the applet. In such a case, the applet may begin executing before any checks are made, and the applet execution may be stopped if the checks indicate that the license is not valid. Metering records may be generated when loading, executing, or terminating the execution of the applet, as well as prior to loading or after terminating the execution of the applet.

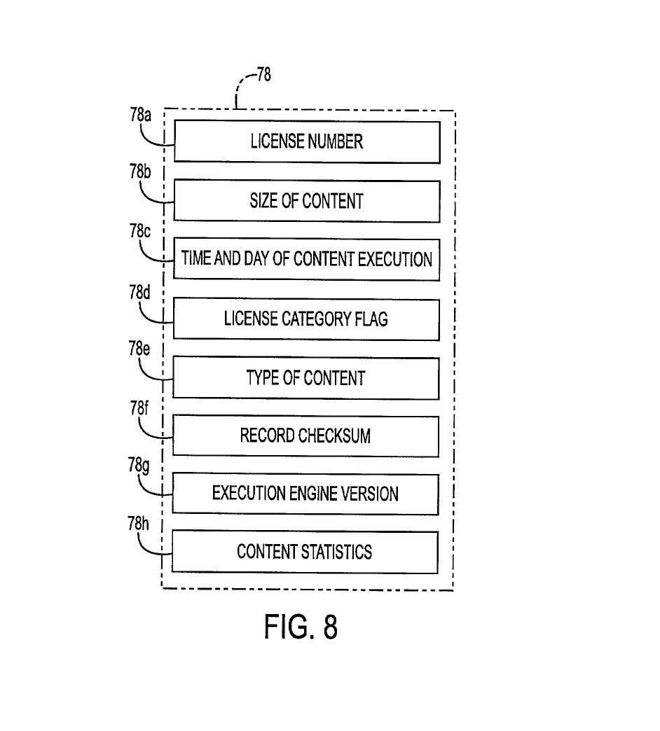

Referring now to FIG. 8, an illustrative view of a metering record generated in accordance with the principles of the present invention is described. Metering record 78 contains information fields 78a-h collected about a content file being executed by content user 50, such as: (1) license number identifying the licensed technology used by a content provider to create the content file (78a); (2) size of the content file (78b); (3) time and day of execution of the content file (78c); (4) license category flag indicating whether the content file has a commercial or a non-commercial licensing tag (78d); (5) the type of content file, e.g., an applet, package or standalone web-based application (78e); (6) a record checksum to verify the contents of the metering record (78f); (7) the version of the execution engine used to deploy the content file (78g); and (8) assorted statistics (78g), such as the amount of time the content file was used or the degree of interactivity of the content file, among others.

Metering record 78 is used by financial data warehouse 61 (FIG. 6) to determine the proper billing for the use of the content as described hereinabove. It should be understood by one skilled in the art that one or more of fields 78a-g in metering record 78 may be used to generate the billing information. For example, the content provider may be billed according to the size of the content file being executed by the user. Alternatively, the content provider may be billed based on the size of the content file as well as on the time the content was executed by the user. One skilled in the art should also understand that there may be variations in metering record 78. Some of the fields 78a-h may not be present in metering record 78 or it may contain additional fields.

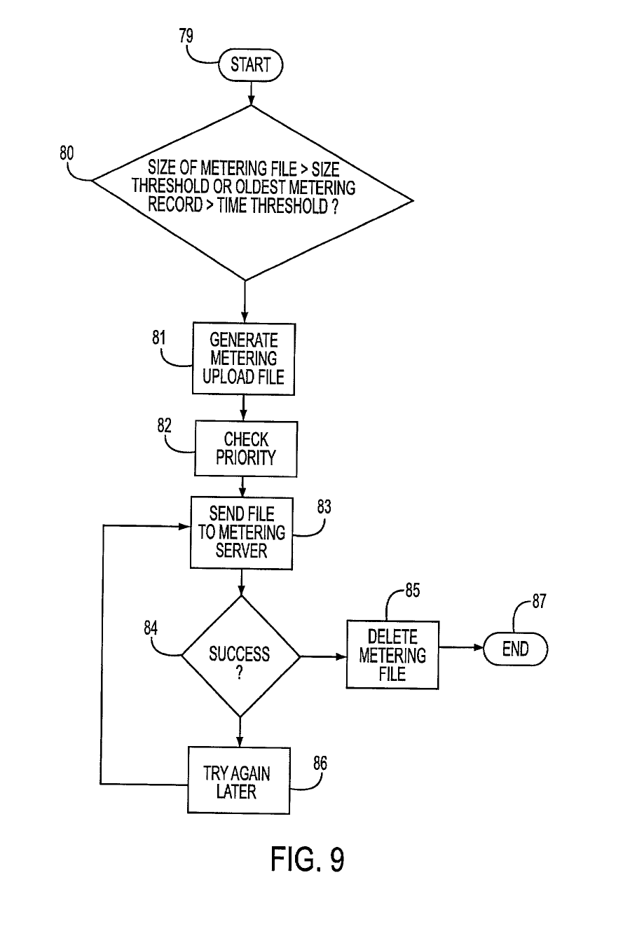

Referring now to FIG. 9, a flowchart for transmitting a metering file to the metering server is described. At step 80, the size and time of creation of the metering file are checked by metering module 44. If the size of the metering file is bigger than a pre-specified threshold or if the oldest metering record in the file is older than a pre-specified age threshold, then a metering upload file is generated at step 81. The metering upload file contains the information stored in the metering file to be sent to metering server 59. Optionally, at step 82, metering module 44 checks whether the content user is executing the content file or performing any other performance-oriented activity that may take priority over sending the metering upload file to metering server 59. When the priority is cleared, the metering upload file is sent to metering server 59 at step 83.

If metering module 44 determines at step 84 that the metering upload file was transmitted to metering server 59 successfully, then the metering upload file is deleted at step 85 to free space in the content user's computer. Otherwise, if the transmission is not successful, metering module 44 attempts to transmit the files again at a later opportunity (step 86). As described hereinabove, the metering file is transmitted periodically to metering server 59.

Although particular embodiments of the present invention have been described above in detail, it will be understood that this description is merely for purposes of illustration. Specific features of the invention are shown in some drawings and not in others, and this is for convenience only and any feature may be combined with another in accordance with the invention. Steps of the described processes may be reordered or combined, and other steps may be included. Further variations will be apparent to one skilled in the art in light of this disclosure and are intended to fall within the scope of the appended claims.

What is claimed is:

1. A method for licensing a technology platform developed by a content technology provider to a content provider for deploying an applet to a content user, wherein financial compensation to the content technology provider is based on usage of the applet by the content user, the method comprising:
embedding licensing information into the applet;
generating usage data when the applet is executed by the content user;
transmitting the usage data to a server;
determining a licensing fee according to the usage data; and
billing the content provider for the licensing fee.

2. The method of claim 1, wherein the content user comprises a content user on an Intranet.

3. The method of claim 1, wherein the content user comprises a content user on the Internet.

4. The method of claim 1, wherein the technology platform comprises a content language for representing the applet in the content language and an execution engine for displaying and processing the applet.

5. The method of claim 4, wherein the technology platform further comprises a development environment for creating the applet.

6. The method of claim 1, wherein embedding licensing information into the applet comprises embedding a licensing tag into the applet, the licensing tag comprising a license number associated with the content provider and a license category.

7. The method of claim 6, wherein the license category comprises a non-commercial license to deploy non-commercial applets.

8. The method of claim 6, wherein the license category comprises a commercial retail license to deploy commercial applets based on the technology platform, the commercial retail license incurring a licensing fee determined by a standard fee schedule based on metered applet usage.

9. The method of claim 6, wherein the license category comprises a commercial negotiated license to deploy commercial applets based on the technology platform, wherein the terms of the license are negotiated between the content provider and the content technology provider.

10. The method of claim 1, wherein the usage data comprises one or more data items selected from a group consisting of: the size of the applet; the time and day of execution of the applet; the version of the execution engine used to process the applet; the amount of time during which the applet was executed; and the degree of interactivity of the applet.

11. The method of claim 10, wherein the usage data is stored into a metering record.

12. The method of claim 11, wherein the metering record comprises one or more data fields selected from a group consisting of: a license number data field associated with the content provider; a size data field containing the size of the applet; a data field containing the time and day of execution of the applet; a license category data field indicating whether the applet contains commercial content; a record checksum data field to verify the contents of the metering record; a version data field indicating the version of the execution engine used to process the applet; and an applet statistics data field.

13. The method of claim 12, further comprising storing the metering record into a metering database.

14. The method of claim 1, further comprising validating the licensing information to verify whether the license number is a valid license number assigned by the content technology provider.

15. The method of claim 1, wherein transmitting the usage data to a server comprises storing a plurality of metering records into a metering file and transmitting the metering file to the server.

16. The method of claim 15, where in transmitting the metering file to the server comprises:
determining the time of creation of one or more metering records in the metering file;
comparing the size of the metering file to a size threshold;
comparing the time of creation of one or more metering records in the metering file to a time threshold; and
transmitting the metering file to the server if the size of the metering file is larger than the size threshold or if the time of creation of one or more metering records in the metering file is older than the time threshold.

17. The method of claim 1, further comprising providing a financial data warehouse for determining the licensing fee for the technology platform based on the usage data.

18. The method of claim 1, wherein billing the content provider for the licensing fee comprises sending a financial invoice to the content provider, charging a credit card number provided by the content provider with an amount corresponding to the licensing fees, or charging the content provider through an on-line payment service.

19. The method of claim 1, further comprising allowing the content provider to verify the status of the license and the licensing fee.

20. The method of claim 19, wherein allowing the content provider to verify the status of the license and the licensing fee comprises providing customer service.

21. The method of claim 19, wherein allowing the content provider to verify the status of the license and the licensing fee comprises providing an account web site to allow the content provider to check a billing summary and a usage summary of the applet.

22. A method for metering the usage of an applet deployed by a content provider based on a technology platform licensed by a content technology provider, the method comprising:
embedding licensing information into the applet;
determining whether the licensing information indicates that the applet contains commercial content;
generating usage data and transmitting the usage data to a server associated with the content technology provider when an applet containing commercial content is executed by a content user; and
charging the content provider a licensing fee based on the usage data.

23. The method of claim 22, wherein the content user comprises a content user on an Intranet.

24. The method of claim 22, wherein the content user comprises a content user on the Internet.

25. The method of claim 22, wherein the technology platform comprises a content language for representing the applet in the content language and an execution engine for displaying and processing the applet.

26. The method of claim 22, wherein the technology platform further comprises a development environment for creating the applet.

27. The method of claim 22, wherein embedding licensing information into the applet comprises embedding a licensing tag into the applet, the licensing tag comprising a license number associated with the content provider and a license category.

28. The method of claim 27, wherein the license category comprises a non-commercial license to deploy non-commercial applets.

29. The method of claim 27, wherein the license category comprises a commercial retail license to deploy commercial applets based on the technology platform, the commercial retail license incurring a licensing fee determined by a standard fee schedule based on metered applet usage.

30. The method of claim 27, wherein the license category comprises a commercial negotiated license to deploy commercial applets based on the technology platform, wherein the terms of the license are negotiated between the content provider and the content technology provider.

31. The method of claim 22, wherein determining whether the licensing information indicates that the applet contains commercial content comprises verifying whether the license category of the applet is a commercial retail license or a commercial negotiated license.

32. The method of claim 22, wherein the usage data comprises one or more data items selected from a group consisting of: the size of the applet; the time and day of execution of the applet; the version of the execution engine used to process the applet; the amount of time during which the applet was executed; and the degree of interactivity of the applet.

33. The method of claim 32, wherein the usage data is stored into a metering record.

34. The method of claim 32, wherein the metering record comprises one or more data fields selected from a group consisting of: a license number data field associated with the content provider; a size data field containing the size of the applet; a data field containing the time and day of execution of the applet; a license category data field indicating whether the applet contains commercial content; a record checksum data field to verify the contents of the metering record; a version data field indicating the version of the execution engine used to process the applet; and an applet statistics data field.

35. The method of claim 33, wherein the metering record is stored into a metering database.

36. The method of claim 22, further comprising validating the licensing information to verify whether the license number is a valid license number assigned by the content technology provider.

37. The method of claim 22, wherein transmitting the usage data to a server comprises storing a plurality of metering records into a metering file and transmitting the metering file to the server.

38. The method of claim 37, wherein transmitting the metering file to the server comprises:
determining the time of creation of one or more metering records in the metering file;
comparing the size of the metering file to a size threshold;
comparing the time of creation of one or more metering records in the metering file to a time threshold; and
transmitting the metering file to the server if the size of the metering file is larger than the size threshold or if the time of creation of one or more metering records in the metering file is older than the time threshold.

39. The method of claim 22, further comprising providing a financial data warehouse for determining the licensing fee for the technology platform based on the usage data.

40. The method of claim 22, wherein charging the content provider a licensing fee based on the usage data comprises sending a financial invoice to the content provider, charging a credit card number provided by the content provider with an amount corresponding to the licensing fee, or charging the content provider through an on-line payment service.

41. The method of claim 22, further comprising allowing the content provider to verify the status of the license and the licensing fee.

42. The method of claim 41, wherein allowing the content provider to verify the status of the license and the licensing fee comprises providing customer service.

43. The method of claim 41, wherein allowing the content provider to verify the status of the license and the licensing fee comprises providing an account web site to allow the content provider to check a billing summary and a usage summary of the applet.

44. A system for licensing a technology platform developed by a content technology provider to a content provider for deploying an applet to a content user, wherein financial compensation to the content technology provider is based on usage of the applet by the content user, the system comprising:
an execution engine to display and process the applet;
a metering module in the execution engine to generate usage data when the applet is executed by the content user;
a metering server to process the usage data; and
an account invoicing system to charge the content provider a licensing fee for deploying the applet with the technology platform.

45. The system of claim 44, wherein the content user comprises a content user on an Intranet.

46. The system of claim 44, wherein the content user comprises a content user on the Internet.

47. The system of claim 44, wherein the technology platform comprises a content language for representing the applet in the content language and an execution engine for displaying and processing the applet.

48. The system of claim 47, wherein the technology platform further comprises a development environment for creating the applet.

49. The system of claim 44, wherein the execution engine to display and process the applet comprises an execution engine selected from a group consisting of: a plug-in to web browser software; a software routine fully integrated into and part of the web browser software; and a standalone software routine associated with the web browser software.

50. The system of claim 44, wherein the usage data comprises one or more data items selected from a group consisting of: the size of the applet; the time and day of execution of the applet; the version of the execution engine used to process the applet; the amount of time during which the applet was executed; and the degree of interactivity of the applet.

51. The system of claim 44, wherein the usage data is stored into a metering record.

52. The system of claim 51, wherein the metering record comprises one or more data fields selected from a group consisting of: a license number data field associated with the content provider; a size data field containing the size of the applet; a data field containing the time and day of execution of the applet; a license category data field indicating whether the applet contains commercial content; a record checksum data field to verify the contents of the metering record; a version data field indicating the version of the execution engine used to process the applet; and an applet statistics data field.

53. The system of claim 51, wherein the metering record is stored into a metering database.

54. The system of claim 44, further comprising a license assignment server to assign the license number to the content provider.

55. The system of claim 44, further comprising a verification server for verifying the status of the license number.

56. The system of claim 44, further comprising a financial data warehouse for determining the licensing fee for the technology platform based on the usage data.

57. The system of claim 44, wherein the account invoicing system comprises software routines for sending a financial invoice to the content provider, charging a credit card number provided by the content provider with an amount corresponding to the licensing fee, or charging the content provider through an on-line payment service.

58. The system of claim 44, further comprising a billing authorization service for checking the validity of financial information submitted by a commercial content provider when requesting a license to use the technology platform.

59. The system of claim 44, further comprising allowing the content provider to verify the status of the license and the licensing fee.

60. The system of claim 59, wherein allowing the content provider to verify the status of the license and the licensing fee comprises providing customer service.

61. The system of claim 59, wherein allowing the content provider to verify the status of the license and the licensing fee comprises providing an account web site to allow the content provider to check a billing summary and a usage summary of the applet.

62. A software system on a content user's computer for metering the usage of an applet deployed by a content provider based on a technology platform licensed to the content provider by a content technology provider, the software system comprising:
an execution engine to display and process the applet;
a metering module in the execution engine to generate usage data when the applet is executed by the content user;
a routine that transmits the usage data to a metering server to process the usage data for the purpose of determining a licensing fee charged to the content provider for deploying the applet with the technology platform.

63. The software system of claim 62, wherein the content user comprises a content user on an Intranet.

64. The software system of claim 62, wherein the content user comprises a content user on the Internet.

65. The software system of claim 62, wherein the technology platform comprises a content language for representing the applet in the content language and an execution engine for displaying and processing the applet.

66. The software system of claim 62, wherein the technology platform further comprises a development environment for creating the applet.

67. The software system of claim 62, wherein the applet contains a licensing tag comprising a license number associated with the content provider and a license category.

68. The software system of claim 67, wherein the license category comprises a category chosen from a group consisting of: a non-commercial license; a commercial retail license; and a commercial negotiated license.

69. The software system of claim 62, wherein the usage data comprises one or more data selected from a group consisting of: the size of the applet; the time and day of execution of the applet; the version of the execution engine used to process the applet; the amount of time during which the applet was executed; and the degree of interactivity of the applet.

70. The software system of claim 62, wherein the usage data is stored into a metering record.

71. The software system of claim 70, wherein the metering record comprises one or more data fields selected from a group consisting of: a license number data field associated with the content provider; a size data field containing the size of the applet; a data field containing the time and day of execution of the applet; a license category data field indicating whether the applet contains commercial content; a record checksum data field to verify the contents of the metering record; a version data field indicating the version of the execution engine used to process the applet; and an applet statistics data field.

72. The software system of claim 62, wherein the routine that transmits the usage data to a metering server comprises a routine for storing a plurality of metering records into a metering file and transmitting the metering file to the metering server.

73. The software system of claim 71, wherein transmitting the metering file to the metering server comprises:
determining the time of creation of one or more metering records in the metering file;
comparing the size of the metering file to a size threshold;
comparing the time of creation of one or more metering records in the metering file to a time threshold;
transmitting the metering file to the metering server if the size of the metering file is larger than the size threshold or if the time of creation of one or more metering records in the metering file is older than the time threshold.

74. A system for licensing a technology platform developed by a content technology provider to a content provider for deploying an applet to a content user, wherein financial compensation to the content technology provider is based on usage of the applet by the content user, the system comprising:
execution engine means for displaying and processing the applet;
metering means in the execution engine means for generating usage data when the applet is executed by the content user;
metering server means for processing the usage data; and
account invoicing means for charging the content provider a licensing fee for deploying the applet with the technology platform.

75. A method for licensing a technology platform to a content provider for deploying an applet to a content user, the method comprising:
embedding licensing information into the applet;
generating usage data when the applet is executed by the content user;
transmitting the usage data to a server;
determining a licensing fee according to the usage data; and
billing the content provider for the licensing fee.
